(19) United States
(12) Patent Application Publication
(10) Pub. No.: US 2024/0188010 A1
(43) Pub. Date: Jun. 6, 2024

(54) TERMINAL, BASE STATION, AND COMMUNICATION METHOD

(71) Applicant: Panasonic Intellectual Property Corporation of America, Torrance, CA (US)

(72) Inventors: Toshiyuki MAKINO, Kanagawa (JP); Takashi IWAI, Ishikawa (JP); Akihiko NISHIO, Osaka (JP)

(21) Appl. No.: 18/552,866

(22) PCT Filed: Jan. 6, 2022
(86) PCT No.: PCT/JP2022/000199

§ 371 Date: Sep. 27, 2023

(30) Foreign Application Priority Data
Mar. 29, 2021 (JP) 2021-056210

(51) Int. Cl. H04W 56/00; H04W 74/0808

(52) U.S. Cl. CPC H04W 56/001; H04W 74/0808

(57) ABSTRACT

This terminal includes a receiving circuit for receiving a synchronization signal, and a control circuit for determining a correspondence relationship between a synchronization signal block transmission position and a synchronization signal block index, wherein the control circuit changes the correspondence relationship between the synchronization signal block transmission position and the synchronization signal block at a first reception timing of the synchronization signal block and a second reception timing thereof.

### TECHNICAL FIELD

The present disclosure relates to a terminal, a base station, and a communication method.

### BACKGROUND ART

Third Generation Partnership Project (3GPP) supports use of an unlicensed band to extend the frequency bands. In 3GPP, SSB operation in the unlicensed band of 52.6 GHZ-71 GHz bands is studied. Note that SSB is an abbreviation for SS/PBCH Block. SS is an abbreviation for Synchronization Signal. PBCH is an abbreviation for Physical Broadcast CHannel.

### CITATION LIST

### Non-Patent Literature

### NPL 1

R1-2102238, 3GPP TSG-RAN WG1 Meeting #104e

### NPL 2

R1-2007926, 3GPP TSG-RAN WG1 Meeting #103e

### NPL 3

3GPP TS 38.213 V16.3.0 (2020-09)

### SUMMARY OF INVENTION

In the unlicensed band, for example, a base station performs a Listen Before Talk (LBT) procedure prior to signal transmission. In the LBT procedure, the base station checks whether the signal transmission band is not used by another radio station and then transmits a signal.

However, in current discussion, the terminal may not be able to receive an SSB index due to an LBT failure.

One non-limiting and exemplary embodiment of the present disclosure facilitates providing a terminal, a base station, and a communication method capable of receiving an index of a synchronization signal block even when an LBT failure occurs.

A terminal according to one exemplary embodiment of the present disclosure includes: reception circuitry, which, in operation, receives a synchronization signal; and control circuitry, which, in operation, determines a correspondence relation between a transmission position of a synchronization signal block and an index of the synchronization signal block, in which the control circuitry changes the correspondence relation between a first reception timing and a second reception timing of the synchronization signal block.

Note that these general or specific aspects may be realized by a system, an apparatus, a method, an integrated circuit, a computer program, or a recording medium, and may be realized by any combination of a system, an apparatus, a method, an integrated circuit, a computer program, and a recording medium.

According to one exemplary embodiment of the present disclosure, it is possible for a terminal receive an index of a synchronization signal block even when an LBT failure occurs.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates one example of a transmission period and a transmission periodicity of an SSB;

FIG. 2 illustrates an exemplary cyclic transmission of the SSB index;

FIG. 3 illustrates one example in which cyclic transmission of the SSB index cannot be performed:

FIG. 4 illustrates one example of the cyclic transmission performed when the number of SSB indexes to be transmitted is reduced;

FIG. 5 illustrates one example in which a relation between the SSB transmission position and the SSB index according to Embodiment 1 is changed between SS burst sets;

FIG. 6 is a block diagram illustrating a configuration example of a base station;

FIG. 7 is a block diagram illustrating another configuration example of the base station;

FIG. 8 is a block diagram illustrating a configuration example of a terminal;

FIG. 9 illustrates an exemplary operation of from cell search to a random access procedure performed between the base station and the terminal;

FIG. 10 is a block diagram illustrating a configuration example of a base station according to Embodiment 2;

FIG. 11 is a block diagram illustrating a configuration example of a terminal according to Embodiment 2;

FIG. 12 illustrates an exemplary operation of from cell search to a random access procedure performed between the base station and the terminal;

FIG. 13 illustrates an exemplary operation of from signal quality measurement and measurement information report performed using the SSB between the base station and the terminal according to Embodiment 3;

FIG. 14 illustrates an exemplary architecture for a 3GPP NR system;

FIG. 15 is a schematic drawing that shows a functional split between NG-RAN and 5GC,

FIG. 16 is a sequence diagram for RRC connection setup/reconfiguration procedures;

FIG. 17 is a schematic diagram illustrating usage scenarios of enhanced Mobile BroadBand (eMBB), massive Machine Type Communications (mMTC), and Ultra Reliable and Low Latency Communications (URLLC); and

FIG. 18 is a block diagram illustrating an exemplary 5G system architecture for a non-roaming scenario.

### DESCRIPTION OF EMBODIMENTS

Hereinafter, embodiments of the present disclosure will be described in detail with reference to the drawings as appropriate. However, any unnecessarily detailed description may be omitted. For example, detailed descriptions of well-known matters and redundant descriptions of substantially the same configuration may be omitted. This is to avoid the unnecessary redundancy of the following description and to facilitate understanding of those skilled in the art.

It is to be noted that the accompanying drawings and the following description are provided to enable those skilled in the art to fully understand this disclosure, and are not intended to limit the claimed subject.

### Embodiment 1

In the standardization of 5G, a new radio access technique (New Radio (NR)) that is not necessarily backward compatible with LTE/LTE-Advanced has been discussed in 3GPP. In Release 17 of NR, the operation in 52.6 GHz to 71 GHz bands as new frequency bands has been studied. In the 52.6 GHz-71 GHz bands, an SSB transmission method by a base station has been studied in order to realize initial connection and quality measurement in NR Stand-alone that allows NR stand-alone operation. Note that LTE is an abbreviation for Long Term Evolution.

The SSB is composed of a Primary Synchronization Signal (PSS), a Secondary Synchronization Signal (SSS), PBCH, and PBCH-De-Modulate Reference Signal (DMRS). The PSS/SSS is a synchronization signal, and the terminal synchronizes with a carrier frequency using the PSS/SSS.

A Physical Cell ID (PCID) of a cell is decoded from the PSS/SSS. The PBCH and PBCH-DMRS are allocated in symbols before and after the PSS/SSS. The PBCH includes a part of broadcast information, and a terminal can obtain a System Frame Number (SFN) indicating the number of a 10-ms time frame in which the SSB is transmitted, a half frame bit for determining the S-ms first half or the 5-ms second half of the time frame, a downlink control signal for initial connection, an assigned resource for a downlink data signal, and/or the like.

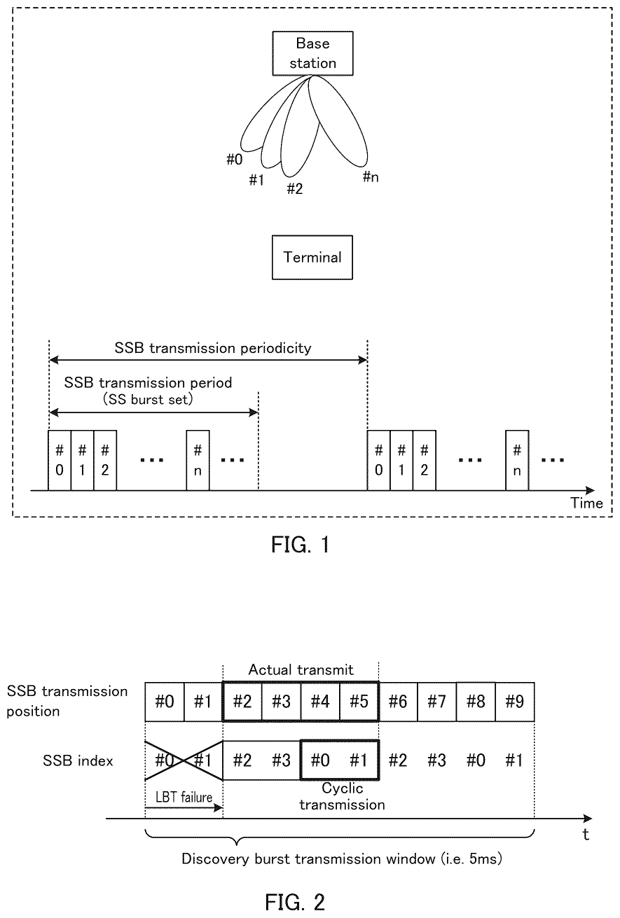

FIG. 1 is a diagram illustrating an exemplary transmission period and a transmission periodicity of the SSB. In NR of Release 16, for example, as illustrated in FIG. 1, the SSB is transmitted alone or as a set of a plurality of SSBs in a transmission period called “SS burst set.” The SS burst set is transmitted at a {5/10/20/40/80/160} ms periodicity. The SS burst set is configured as a transmission period of 5 ms or below that starts from the beginning of the 10-ms time frame or the beginning of the time frame+the half frame (5 ms).

SSBs within the SS burst set are transmitted as signals with different SSB indexes. Each of the SSB indexes indicates an SSB transmission position within the SS burst set, and the terminal decodes the SSB index to identify the starting point of the time frame.

The maximum number of SSB indexes within the SS burst set is determined for each band. In NR of Release 17, it was agreed that, like Release 16, the maximum number of SSB indexes within the band above 6 GHz is 64. The SSB index is uniquely associated with a PBCH and a PBCH-DMRS sequence and indicated to the terminal.

In a high frequency band, transmission beamforming is considered to be applied at the base station side in order to secure a distance and a area in which communication is possible between the base station and the terminal. In NR, a beam management function using the SSB has been introduced. Different SSB indexes within the SS burst set are transmitted with different downlink transmission beams. It is thus possible to realize beam-sweeping in which the beams are sequentially switched for transmission. The beams may be an analogue beam.

The terminal measures downlink reception quality for each SSB within the SS burst set and determines an optimal downlink transmission beam. When the base station applies downlink transmission beamforming to the SSB, an equivalent uplink reception beam is applied at the base station side in order to receive random access from the terminal that has received the SSB. The terminal transmits a Physical Random Access Channel (PRACH) in a Rach Occasion (RO), which is a resource associated with the detected SSB. By performing random access in the RO associated with the SSB index, optimal downlink transmission/reception beams can be formed between the base station and the terminal.

In NR-U which is an NR operation in the unlicensed band defined in Release 16, a Discovery Burst Transmission Window (DBTW) is introduced as an SS burst set transmission method. In the unlicensed band, a Listen Before Talk (LBT) procedure is performed prior to transmission.

In the LBT procedure, a signal is transmitted after confirmation as to whether or not a signal transmission band is used by another radio station (channel busy). If an LBT failure occurs, the signal transmission cannot be performed, and therefore an SS burst set transmission start timing in NR-U is not always from the beginning of a time frame or from the beginning of the time frame+half frame (5 ms). Therefore, there is a possibility that the SSB cannot be transmitted at the first SSB transmission position within the SS burst set. Therefore, in the DBTW, cyclic transmission of the SSB index can be performed at different SSB transmission positions in the transmission period. Note that the LBT failure may be referred to as “channel busy” or “LBT busy.”

FIG. 2 is a diagram illustrating one exemplary cyclic transmission of the SSB indexes. The terminal is notified of SSB transmission positions. The terminal calculates the SSB indexes from the decoded SSB transmission positions using a predetermined equation. Since the downlink transmission beams are associated with the SSB indexes, the terminal can measure the downlink reception quality on the assumption that the propagation properties are the same even at different SSB transmission positions. Therefore, the DBTW allows the base station to avoid incapability of transmitting a particular SSB even in the LBT failure.

With respect to the 52.6 GHz-71 GHz bands, operation in the unlicensed band is also assumed, and introduction of the DBTW is studied (see, for example, Non-Patent Literature (hereinafter, referred to as “NPL”) 1).

In the 52.6 GHz-71 GHz bands, the maximum number of SSB indexes supported for the unlicensed band is larger than the maximum number of SSB indexes supported conventionally (for the FR1 band), and accordingly, when the DBTW is operated in the unlicensed band, the number of SSB indexes to be transmitted becomes substantially the same as the number of SSB transmission positions that can be indicated. This case causes a problem that there is an SSB index at which transmission cannot be performed due to the LBT failure, and the performance of a particular terminal deteriorates. Note that FR1 is an abbreviation for Frequency Range 1.

In NR-U defined in Release 16, the maximum number of SSB indexes and the number of SSB transmission positions that can be indicated to the terminal are based on the subcarrier spacing (SCS: Sub-Carrier Space).

For example, when the SCS is 15 KHz, the maximum number of SSB indexes is 4, and the number of SSB transmission positions that can be indicated to the terminal is 10. When SCS is 30 KHz, the maximum number of SSB indexes is 8, and the number of SSB transmission positions that can be indicated to the terminal is 20. Therefore, when the LBT failure occurs within the DBTW, the number of times that the cyclic transmission of the SSB can be performed at different transmission positions is two or more for both the SSB indexes.

Meanwhile, in the 52.6 GHZ-71 GHz bands, it is agreed that the maximum number of SSB indexes is 64 in order to obtain a larger beamforming gain. Further, assuming that the number of SSB transmission positions that can be indicated is 64 defined in Release15 for FR2 (6 GHz-52.6 GHz bands), the cyclic transmission of the SSB index at different SSB transmission positions using the DBTW is impossible.

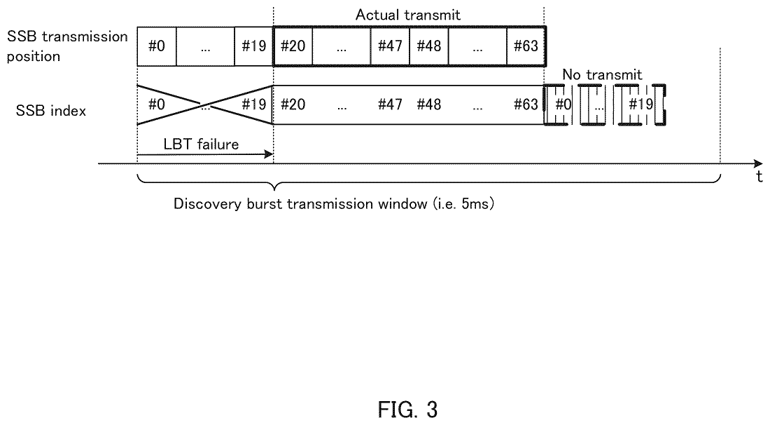

FIG. 3 is a diagram illustrating one exemplary case where the cyclic transmission of SSB indexes is impossible. As illustrated in FIG. 3, when an LBT failure occurs, transmission cannot be performed at SSB indexes associated with the SSB transmission positions at the beginning of the DBTW, and the performance of the terminal for which the transmission beams corresponding to the SSB indexes are optimal deteriorates.

FIG. 3 illustrates an example assuming that the SCS is 120 kHz, the number of SSB transmission positions is 64, and the number of SSB transmission positions per 1 slot is 2. The period including all SSB transmission positions is shorter than the DBTW of 5 ms.

In order to cope with the problem as described above, a measure of reducing the number of SSB indexes to be transmitted, so as to achieve the cyclic transmission has been proposed (for example, NPL 2).

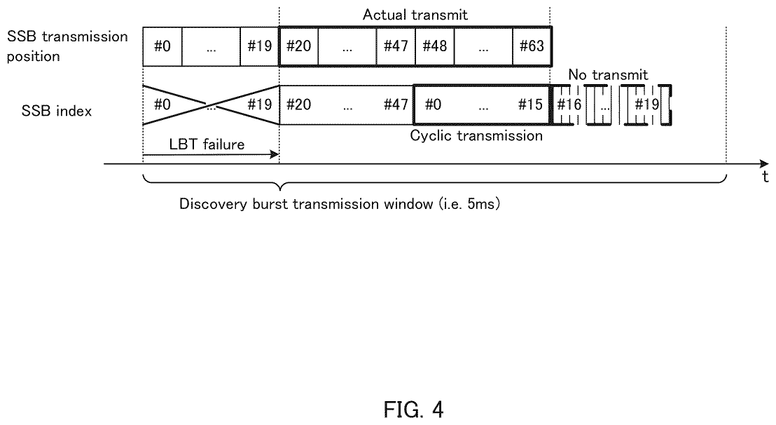

FIG. 4 is a diagram illustrating one exemplary cyclic transmission performed when the number of SSB indexes to be transmitted is reduced. NPL 2 assumes, for example, that SSB indexes {0, . . . , 47} are transmitted at SSB transmission positions {0, . . . , 47} and SSB indexes {0, . . . , 15} are cyclically transmitted at SSB transmission positions {48, . . . , 63}. However, even in this case, if the LBT failure occurs at SSB transmission positions {0, . . . , 19} occurs, transmission cannot be performed at SSB indexes {16, . . . , 19}.

As described above, those SSB indexes which are associated with the beginning or the first half of the SSB transmission positions tend to be the SSB indexes at which transmission cannot be performed due to the LBT failure. Therefore, particular terminals for which transmission beams corresponding to particular SSB indexes are optimal tend to be affected by performance degradation due to the LBT failure. Therefore, the performance of the particular terminals greatly deteriorates.

Therefore, in Embodiment 1, the relation between the SSB transmission positions and the SSB indexes is changed between the base station and the terminal, to suppress the tendency that the particular terminals are affected by performance degradation due to the LBT failure.

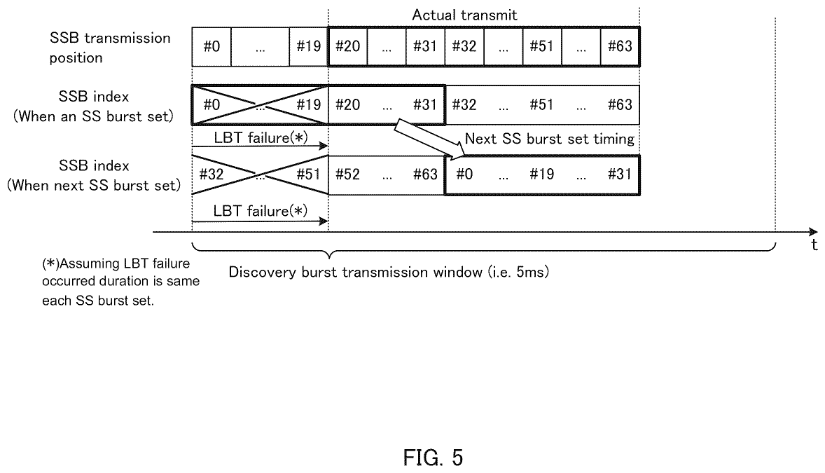

FIG. 5 is a diagram illustrating one example according to Embodiment 1 in which the relation between the SSB transmission positions and the SSB indexes is changed between the SS burst sets. As illustrated in FIG. 5, when the relation between the SSB transmission positions and the SSB indexes is changed between the SS burst sets, it is possible to eliminate the tendency of SSB indexes at which the base station cannot perform transmission due to the LBT failure.

For example, in the example of FIG. 5, transmission cannot be performed at SSB indexes {#0, . . . , #19} associated with SSB transmission positions {#0, . . . , #19} due to the LBT failure in an SS burst set. However, by associating SSB indexes {#0, . . . , #19} with SSB transmission positions {#32, . . . , #51} of the second half in a different SS burst set, transmission can be performed at SSB indexes {#0, . . . , #19} even when the LBT failure occurs at SSB transmission positions {#0, . . . , #19} in the same period. However, the correspondence relation between the SSB transmission positions and the SSB indexes must be recognized consistently by the base station and the terminal. When the correspondence relation is not recognized consistently, it is impossible to form an optimal downlink transmission/reception beam between the base station and the terminal.

In the following, a description will be given of an terminal operation of initial connection and quality measurement using SSBs in which the relation between the SSB transmission positions and the SSB indexes are changed between the base station and the terminal. In addition, methods for determining the relation between the SSB transmission positions and the SSB indexes by the base station and the terminal based on a signal periodically transmitted by the base station will be described. Note that the determination may be referred to as calculation.

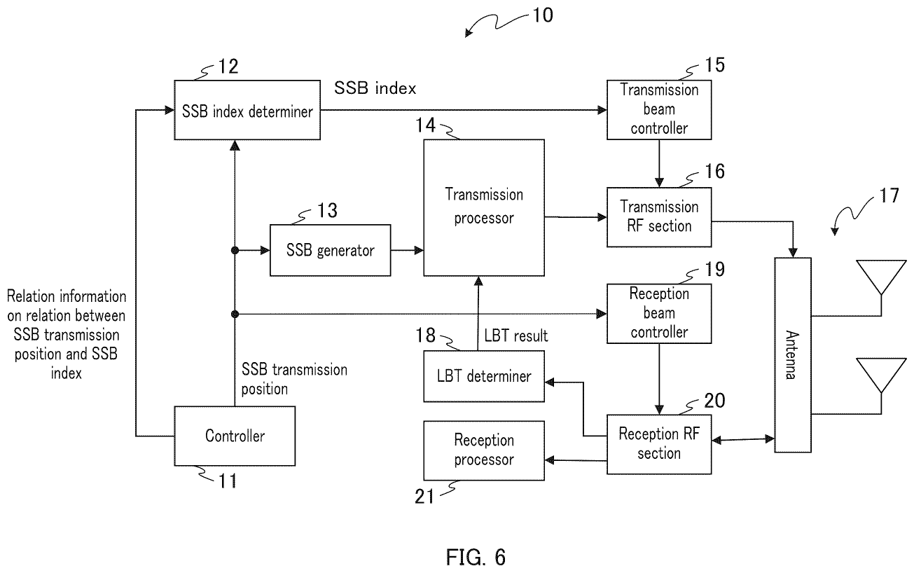

FIG. 6 is a block diagram illustrating a configuration example of base station 10. Controller 11 performs periodicity configuration of an SS burst set, updating of an SFN, and the like. In addition, controller 11 performs scheduling of a control signal and a data signal for initial connection.

Controller 11 outputs SSB transmission positions in an SS burst set to SSB generator 13 and SSB index determiner 12 in accordance with an SSB transmission timing. Controller 11 outputs information for determining the relation between the SSB transmission positions and the SSB indexes to SSB index determiner 12.

The information for determining the relation between the SSB transmission positions and the SSB indexes includes, for example, an SFN, half frame bit, PCID, and the like. Hereinafter, the information for determining the relation between the SSB transmission positions and the SSB indexes will be referred to as relation information on the relation between the SSB transmission positions and the SSB indexes.

SSB index determiner 12 determines the SSB indexes based on the SSB transmission positions and the relation information on the relation between the transmission positions and the SSB indexes, and outputs the determined SSB indexes to transmission beam controller 15. Details of a changing method for SSB index determiner 12 will be described later

Based on the inputted SSB transmission positions, SSB generator 13 generates a signal sequence of each of a PSS/SSS, PBCH, and PBCH-DMRS, and outputs the signal sequences to transmission processor 14. The PSS/SSS is generated by a correlation sequence based on the PCID of base station 10. The PBCH-DMRS is generated using the DMRS sequence based on the SSB transmission positions. The PBCH is generated by encoding and modulating PBCH information including the SSB transmission positions. The PBCH information includes information such as the SSB transmission positions, SFN, half frame bit, and assigned resources for a control signal for initial connection and a data signal. Note that, in the present disclosure, the assigned resources for the control signal for initial connection and the data signal may be determined based on any one of the SSB transmission positions and SSB indexes.

Transmission processor 14 maps signal sequences of SSBs inputted by SSB generator 13 to respective resources, performs processing such as OFDM modulation, and generates a transmission signal. Further, transmission processor 14 confirms, to LBT determiner 18, a usage status of a transmission signal band, and outputs the transmission signal to transmission RF section 16 when the LBT is completed.

Transmission beam controller 15 outputs downlink transmission beam directions corresponding to the SSB indexes inputted by SSB index determiner 12 to transmission RF section 16.

Transmission RF section 16 generates a radio signal by performing processing such as D/A conversion, up-conversion, and amplification on the transmission signal inputted by transmission processor 14, and outputs the radio signal to antenna 17. In addition, transmission RF section 16 performs adjustment of the phases and amplitudes of antenna elements of antenna 17 such that the signal is directed toward a beam direction outputted by transmission beam controller 15.

Antenna 17 emits, to the terminal, the radio signal inputted by transmission RF section 16 by forming a transmission beam controlled by transmission RF section 16. In addition, antenna 17 receives a radio signal from the terminal or another radio station by forming a reception beam at a timing controlled by reception RF section 20. Antenna 17 outputs the received radio signal to reception RF section 20.

LBT determiner 18 performs the LBT by monitoring a radio usage status of a used frequency band from a reception wave inputted by reception RF section 20. When signal transmission is started at base station 10, LBT determiner 18 outputs an LBT result to transmission processor 14.

Reception beam controller 19 outputs uplink reception beam directions for ROs corresponding to the SSB transmission positions to reception RF section 20.

Reception RF section 20 performs reception processing such as A/D conversion, down-conversion, and amplification on the radio signal inputted by antenna 17, and outputs the radio signal to reception processor 21. At this time, the phases and amplitudes of the antenna elements of antenna 17 are adjusted such that signals are directed in the beam directions outputted by reception beam controller 19.

Reception processor 21 decodes a PRACH from the reception signal inputted by reception RF section 20, to identify the RO selected by the terminal.

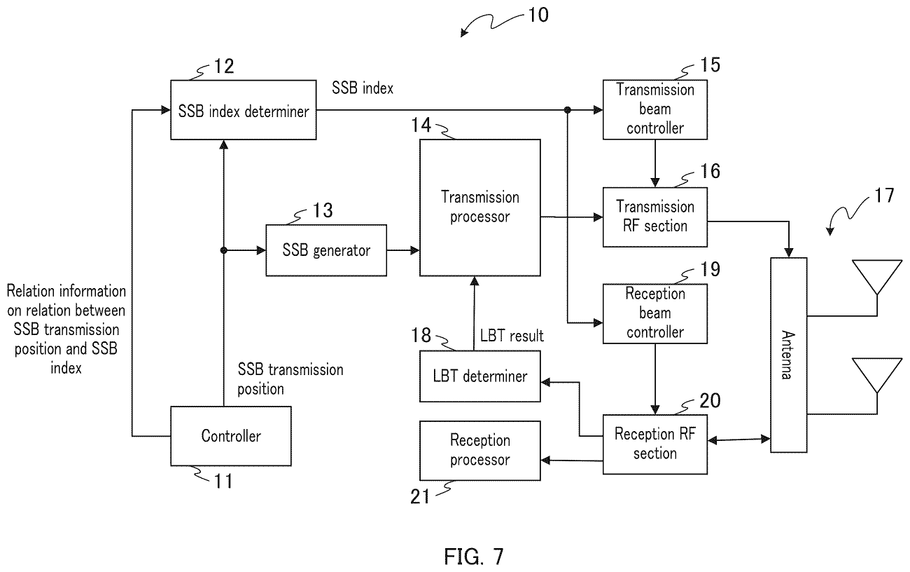

FIG. 7 is a block diagram illustrating another configuration example of base station 10. In FIG. 7, the same components as those in FIG. 6 are denoted by the same reference numerals. In FIG. 7, the SSB transmission positions in controller 11 are outputted to reception beam controller 19.

In base station 10 of FIG. 6, the ROs are associated with the SSB transmission positions. In base station 10 illustrated in FIG. 7, the ROs are associated with the SSB indexes. As illustrated in FIG. 6, when the reception beams of base station 10 for the ROs are associated with the SSB transmission positions, the timings for the beam directions are fixed, and the reception beam control becomes simple. As illustrated in FIG. 7, when the reception beams of base station 10 for ROs are associated with the SSB indexes, the timings for the beam directions are randomized, and periodic interference by another radio station can be avoided.

Note that the periodicities of ROs and SS burst sets do not necessarily have to coincide with each other. Thus, the SSB transmission positions or SSB indexes that the ROs refer to may be those in the relation in a predetermined (e.g., immediately preceding) SS burst set. Alternatively, the SSB transmission positions or SSB indexes referred to by the ROs may be separately calculated from the ROs.

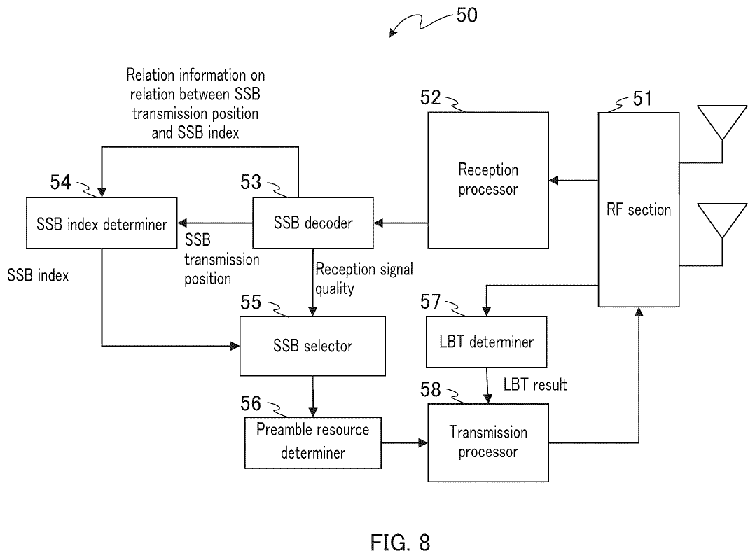

FIG. 8 is a block diagram illustrating a configuration example of terminal 50. RF section 51 performs reception processing such as down-conversion and A/D conversion on a radio signal received from base station 10 or another radio station via an antenna, and outputs the received signal to reception processor 52 and LBT determiner 57. Further, RF section 51 performs transmission processing such as D/A conversion, up-conversion, and amplification on a transmission signal inputted by transmission processor 58, and transmits the resulting radio signal from an antenna to base station 10.

Reception processor 52 detects, by correlation processing or the like, a PSS/SSS of the received signal inputted by RF section 51, to identify a resource for an SSB, and outputs the resource to SSB decoder 53.

SSB decoder 53 detects a PCID from the PSS/SSS. SSB decoder 53 detects a sequence number from a PBCH-DMRS. SSB decoder 53 demodulates and decodes PBCH information from the PBCH. SSB decoder 53 identifies an SSB transmission position from the sequence number of the PBCH-DMRS and PBCH information. In addition, SSB decoder 53 obtains relation information on the relation between the SSB transmission positions and the SSB indexes from the PBCH information. SSB decoder 53 outputs the SSB transmission positions and the relation information on the relation between the SSB transmission positions and the SSB indexes to SSB index determiner 54. SSB decoder 53 measures the received signal quality of each of the SSBs and outputs the measured received signal quality to SSB selector 55.

SSB index determiner 54 determines the SSB indexes based on the SSB transmission positions and the relation information on the relation between SSB transmission positions and SSB indexes inputted by SSB decoder 53, and outputs the SSB indexes to SSB selector 55. A changing method for changing the SSB indexes will be described later. The same operations as those of SSB index determiner 12 included in base station 10 are performed.

SSB selector 55 associates the received signal qualities measured from the SSBs with the SSB indexes, and determines an SSB index having the highest reception quality within the SS burst set. SSB selector 55 outputs the determined SSB index to Preamble resource determiner 56.

Preamble resource determiner 56 selects the RO associated with the inputted SSB index and outputs the RO to transmission processor 58.

It should be noted that base station 10 and terminal 50 consistently recognize the RO transmission/reception timings. Therefore, broadcast information may indicate, to terminal 50, whether the ROs are associated with the reception timings of the SSB transmission positions or with the reception timings of the SSB indexes. Alternatively, it may be known to base station 10 and terminal 50 from common information described in the specifications whether the ROs are associated with the reception timings of the SSB transmission positions or with the reception timings of the SSB indexes.

LBT determiner 57 performs the LBT by monitoring a radio usage status of a used frequency band based on the reception wave inputted by RF section 51. LBT determiner 57 outputs an LBT result to transmission processor 58 when the signal transmission is started at terminal 50.

Transmission processor 58 generates a PRACH transmission signal using the RO received from Preamble resource determiner 56. The generated PRACH transmission signal is outputted to RF section 51. Further, transmission processor 58 confirms the usage status of a transmission signal band to LBT determiner 57, and outputs the transmission signal to RF section 51 when the LBT is completed.

<Initial Connection Operation of Base Station and Terminal Performed when SSB Transmission Position and SSB Index are Different from Each Other>

An initial connection operation of the base station and the terminal performed when an SSB transmission position differs from an SSB index will be described. In the initial connection, the terminal obtains a time frame and/or a resource for the initial connection even when there is no relation information on the relation between the SSB transmission positions and the SSB indexes.

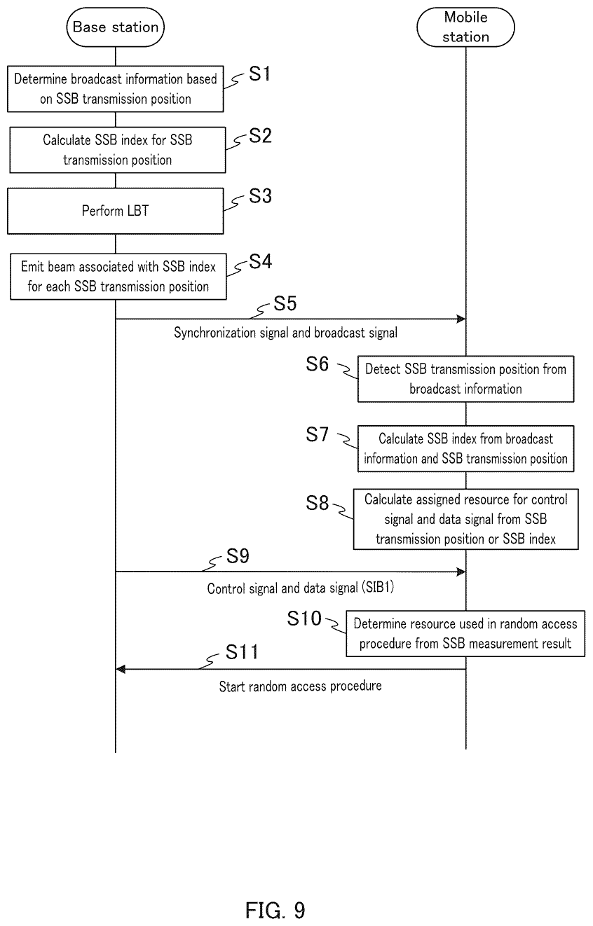

FIG. 9 is a diagram illustrating an exemplary operation of from cell search to a random access procedure performed between the base station and the terminal. The base station determines the broadcast information based on the SSB transmission positions (S1). The base station calculates the SSB indexes for the SSB transmission positions (S2). The base station performs the LBT (S3). The base station emits beams associated with the SSB indexes for the respective SSB transmission positions (S4). The base station transmits the synchronization signal and the broadcast signal to the terminal (S5)

The terminal detects the SSB transmission positions from the broadcast information transmitted at S5 (S6). The terminal calculates the SSB indexes from the broadcast information and the SSB transmission positions (S7). The terminal calculates assigned resources for a control signal and a data signal from the SSB transmission positions or the SSB indexes (S8).

With reference to the assigned resource calculated in S8, the terminal receives the control signal and the data signal (System Information Block Typel (SIB1)) from the base station (S9). The terminal determines a resource (e.g., RO) to be used in the random access procedure from an SSB measurement result (the SSB transmission positions or the SSB indexes) (S10). The terminal starts the random access procedure using the resource determined in S10 (S11).

In the initial connection, the terminal synchronizes with a PSS/SSS to identify a PBCH-DMRS and PBCH in a predetermined resource. At this time, since the terminal can obtain the SSB transmission positions from SSB broadcast information, the terminal can specify the starting point of the time frame.

After the SSB is detected, the terminal detects a data signal in which SIB1 is broadcast and a control signal for indicating resources for the data signal. SIB1 includes the broadcast information used in the random access procedure. In addition, the data signal for SIB1 and the control signal are signals common to the cells. Assigned resources for the common signals for SIB1 are calculated as an offset value from the resources for the SSB. In addition, in order to reduce the amount of information to be indicated, a parameter for calculating the assigned resources for SIB1 is described in a Master Information Block (MIB) of broadcast information of the SSB. Conventionally, the SSB transmission positions are inputted to an expression for calculating the assigned resources for SIB1.

In FIG. 9, the base station and the terminal can calculate the SSB indexes at the time points of processes S2 and S7. Therefore, the terminal can use both the SSB transmission positions and SSB indexes at the time point of detecting the assigned resources for the common signal for SIB1 (for example, at the time point of process S10). For this reason, either the SSB transmission positions or SSB indexes may be used as an input value to the expression for calculating the assigned resources for the common signal for SIB1 in the terminal. When the SSB transmission positions are conventionally used as the input value, there is less change in specifications. When the SSB indexes are used as the input value, the timings for the directions of the transmission beams from the base station are randomized for the SIB1 transmissions as in the case of the reception beams for the ROs, and the terminal can avoid periodic interference and the like by another radio station.

<Operation of Calculating SSB Index from SSB Transmission Position>

Next, the process of calculating the SSB indexes from the SSB transmission positions performed by the SSB index determiners of the base station and the terminal will be described. In the following description, the operation at the terminal side will be described. The base station performs calculation in the same operation as that of the terminal.

Hereinafter, calculation processes 1 and 2 will be described in detail. The calculation expression used in the calculation processes is system common information defined in the specifications. By changing the relation between the SSB transmission positions and the SSB indexes, the base station suppresses the tendency of the SSB indexes at which the base station cannot perform transmission due to the LBT failure. Further, by specifying the changing methods (determination methods) for changing calculation processes 1 and 2 in the specifications, the terminal can calculate the SSB indexes from the SSB transmission positions without any additional signaling from the base station.

Calculation Process 1

The base station changes the relation between the SSB transmission positions and the SSB indexes based on a periodically changed signal (information) such as an SFN and half frame bit included in a PBCH to be indicated to the terminal.

The terminal calculates the SSB indexes from the SSB transmission positions based on the periodically changed signal such as the SFN and half frame bit included in the PBCH indicated by the base station.

Note that the SEN is divided, in the PBCH information, into information included in a PBCH additional bit with a short changing periodicity and information indicated from the MIB with a long changing periodicity, and not all the SFN information pieces have to be referred to. When the information included in the PBCH additional bit is referred to, Embodiment 1 can be applied even to an SSB utilization method which does not include the MIB.

### Calculation Example 1-1

The base station shifts SSB indexes for SSB transmission positions by a fixed amount based on the periodically changed signal (information) such as the SFN and half frame bit included in the PBCH to be indicated to the terminal.

The terminal specifies (determines) the relation between the SSB transmission positions and the SSB indexes by shifting the SSB indexes from the SSB transmission positions by a fixed amount based on the periodically changed signal such as the SFN and half frame bit included in the PBCH indicated by the base station.

By shifting the fixed amount, the transmission beam direction configured by the transmission beam controller of the base station is obtained only by adding a fixed time offset to the relation between the SSB transmission positions and the SSB indexes. Therefore, the transmission beam controller does not need to have a plurality of transmission beam control patterns corresponding to the relation between the SSB transmission positions and the SSB indexes, and can realize the plurality of transmission beam control patterns by an easy implementation.

For example, the SSB indexes are calculated using following Expression 1.

SSB_index=(SSBₚₒₛ−N*(SFN*2+Half_frame_bit))mod L (Expression 1)

Here, SSBₚₒₛ is the SSB transmission position. L is the maximum number of SSB indexes to be transmitted. Nis a fixed shift amount. Note that N may be a value differing among a plurality of different Ls or a plurality of different SCSs.

Exemplary Relation 1-1

The SSB indexes for the SSB transmission positions based on calculation example 1-1 is described below. Table 1 shows an exemplary relation between the SSB transmission positions and the SSB indexes in a case where L=64, N=11, the periodicity of SS burst set is 10 ms (one radio frame), and half frame bit=0.

TABLE 1
Relation between SSB transmission position
and SSB index in Calculation example 1-1

| SSB Transmission Position | 0 | 1 | 2 | . . . | 22 | . . . | 44 | . . . | 63 |
|---|---|---|---|---|---|---|---|---|---|
| SSB index (when | 0 | 1 | 2 | . . . | 22 | . . . | 44 | . . . | 63 |
| SFN is equal to 0) | | | | | | | | | |
| SSB index (when | 42 | 43 | 44 | . . . | 0 | . . . | 22 | . . . | 41 |
| SFN is equal to 1) | | | | | | | | | |
| SSB index (when | 20 | 21 | 22 | . . . | 41 | . . . | 0 | . . . | 19 |
| SFN is equal to 2) | | | | | | | | | |
| SSB index (when | 62 | 63 | 0 | . . . | 20 | . . . | 42 | . . . | 61 |
| SFN is equal to 3) | | | | | | | | | |

### Calculation Example 1-2

The base station shifts SSB indexes for SSB transmission positions by a predetermined variable amount based on the periodically changed signal (information) such as the SFN and half frame bit included in the PBCH to be indicated to the terminal.

The terminal specifies (determines) the relation between the SSB transmission positions and the SSB indexes by shifting the SSB indexes from the SSB transmission positions by the predetermined variable amount based on the periodically changed signal such as the SFN and half frame bit included in the PBCH indicated by the base station. The variable amount may be a periodically varying amount.

For example, the SSB indexes are calculated using following Expression 2.

[2]

SSB_index=(SSBₚₒₛ+floor(L/M)*((SFN+2+Half_frame_bit)mod M))mod L (Expression 2)

Here. SSBₚₒₛ is the SSB transmission position. L is the maximum number of SSB indexes to be transmitted. M is a shift-related amount. If M is one of the numbers (e.g., {3, 5, 7}) coprime to the “SS burst set periodic frame” (i.e., {0.5, 1, 2, 4, 8, 16}), then M times of “SS burst set” bring the relation between the SSB transmission positions and the SSB indexes into the original relation.

If M is a coprime number, the SSB indexes are shifted to SSB transmission positions different between the “SS burst sets” even in the case of different “SS burst set periodic frames” (for example, in each case of periodic frames {1, 2}). Note that M may be a different value among a plurality of Ls or a plurality of SCSs.

The same effect as that of calculation example 1-1 can be obtained also by shifting the variable amount. Furthermore, by using Expression 2, it is possible to obtain the relation between the SSB indexes and the SSB transmission positions different between the SS burst sets independently of the number of SSB indexes and the “SS burst set periodic frame.”

For example, in calculation example 1-1, when L=64 and N=16, the relation between the SSB transmission positions and the SSB indexes is not changed depending on the “SS burst set periodic frame” (for example, when the periodic frame is 2). On the other hand, in calculation example 1-2, since M is a coprime number to the “SS burst set periodic frame,” the relation between the SSB transmission positions and the SSB indexes is constantly changed.

Note that the SSB indexes may be calculated using the SFN without using the half frame bit.

Exemplary Relation 1-2

The SSB indexes for the SSB transmission positions based on calculation example 1-2 are illustrated below. Table 2 shows an exemplary relation between the SSB transmission positions and the SSB indexes in a case where L=64, M=3, the periodicity of SS burst set is 10 ms (one radio frame), and half frame bit=0. When SFN=3, the relation between the SSB transmission positions and the SSB indexes is the same as in SFN=0.

TABLE 2
Relation between SSB transmission position
and SSB index in Calculation example 1-2

| SSB Transmission Position | 0 | 1 | 2 | . . . | 22 | . . . | 44 | . . . | 63 |
|---|---|---|---|---|---|---|---|---|---|
| SSB index (when | 0 | 1 | 2 | . . . | 22 | . . . | 44 | . . . | 63 |
| SFN is equal to 0) | | | | | | | | | |
| SSB index (when | 42 | 43 | 44 | . . . | 0 | . . . | 22 | . . . | 41 |
| SFN is equal to 1) | | | | | | | | | |
| SSB index (when | 20 | 21 | 22 | . . . | 41 | . . . | 0 | . . . | 19 |
| SFN is equal to 2) | | | | | | | | | |
| SSB index (when | 0 | 1 | 2 | . . . | 22 | . . . | 44 | . . . | 63 |
| SFN is equal to 3) | | | | | | | | | |

### Calculation Example 1-3

The base station reverses the order of SSB indexes with respect to the SSB transmission positions based on the periodically changed signal (information) such as the SFN and half frame bit included in the PBCH to be indicated to the terminal.

The terminal determines whether the SSB transmission positions and the SSB indexes are in the forward order or in the reverse order based on the periodically changed signal such as the SFN and half frame bit included in the PBCH indicated by the base station.

By reversing the order and switching in this way, the first SSB index which is likely to be unavailable for transmission due to the LBT failure is replaced to be arranged in the second half at the time of switching. Therefore, it is possible to equalize the probabilities for the SSB indexes to become unavailable for transmission.

Exemplary Relation 1-3

The SSB indexes for the SSB transmission positions based calculation example 1-3 are described below.

TABLE 3
Relation between SSB transmission position
and SSB index in Calculation example 1-3

| SSB Transmission Position | 0 | 1 | 2 | . . . | 22 | . . . | 44 | . . . | 63 |
|---|---|---|---|---|---|---|---|---|---|
| SSB index (when | 0 | 1 | 2 | . . . | 22 | . . . | 44 | . . . | 63 |
| SFN is equal to 0) | | | | | | | | | |
| SSB index (when | 63 | 62 | 61 | . . . | 41 | . . . | 19 | . . . | 0 |
| SFN is equal to 1) | | | | | | | | | |
| SSB index (when | 0 | 1 | 2 | . . . | 22 | . . . | 44 | . . . | 63 |
| SFN is equal to 2) | | | | | | | | | |
| SSB index (when | 63 | 62 | 61 | . . . | 41 | . . . | 19 | . . . | 0 |
| SFN is equal to 3) | | | | | | | | | |

### Calculation Example 1-4

The base station changes the relation of the SSB indexes with respect to the SSB transmission positions based on the periodically changed signal (information) such as the SFN and half frame bit included in the PBCH to be indicated to the terminal, and a pseudo-random number expression or a table described in the specifications or the like.

The terminal identifies the relation between the SSB transmission positions and the SSB indexes based on the periodically changed signal such as the SFN and half frame bit included in the PBCH indicated by the base station, a pseudo-random number expression or a table described in the specifications or the like. The relation between the SSB transmission order and the SSB indexes which is based on the pseudo-random number expression or the table previously described in the specifications or the like allows further randomization of the SSB indexes between the “SS burst sets.”

Exemplary Relation 1-4

The SSB indexes for the SSB transmission positions based on calculation example 1-4 are described below. The pseudo-random number expression or the table for changing the relation between the SSB transmission positions and the SSB indexes according to the SFNs and SSB transmission positions as illustrated in Table 4 is described in the specifications, and the base station and the terminal change the relation between the SSB transmission positions and the SSB indexes depending on the SFNs. At this time, the SSB indexes may not be ordered.

TABLE 4
Relation between SSB transmission position
and SSB index in Calculation example 1-4

| SSB Transmission | | | | | | | | | | |
|---|---|---|---|---|---|---|---|---|---|---|
| Position | 0 | 1 | 2 | 3 | 4 | 5 | 6 | 7 | 8 | . . . |
| SSB index (when | 0 | 1 | 2 | 3 | 4 | 5 | 6 | 7 | 8 | . . . |
| SFN is equal to 0) | | | | | | | | | | |
| SSB index (when | 59 | 49 | 39 | 29 | 19 | 9 | 58 | 48 | 38 | . . . |
| SFN is equal to 1) | | | | | | | | | | |
| SSB index (when | 32 | 30 | 28 | 26 | 24 | 22 | 20 | 18 | 16 | . . . |
| SFN is equal to 2) | | | | | | | | | | |
| SSB index (when | 8 | 16 | 24 | 32 | 40 | 48 | 56 | 7 | 15 | . . . |
| SFN is equal to 3) | | | | | | | | | | |

### Calculation Example 1-5

The above-mentioned calculation examples may be combined. By combining the calculation examples, the effects of the calculation examples can be obtained.

For example, by combining calculation example 1-2 and calculation example 1-3, the relation between the SSB transmission positions and the SSB indexes may be changed as in exemplary relation 1-5 described below. In calculation example 1-3, depending on the “SS burst set periodic frame,” it may happen that the relation between the SSB transmission positions and the SSB indexes is not changed between the SS burst sets (for example, when SFN=0 and SFN=2). On the other hand, the combination as in configuration example 1-5 described below makes it possible to change the relation between the SSB transmission positions and the SSB indexes between the SS burst sets.

Exemplary Relation 1-5

TABLE 5
Relation between SSB transmission position
and SSB index in Calculation example 1-5

| SSB Transmission Position | 0 | 1 | . . . | 21 | 22 | . . . | 63 |
|---|---|---|---|---|---|---|---|
| SSB index (when | 0 | 1 | . . . | 21 | 22 | . . . | 63 |
| SFN is equal to 0) | | | | | | | |
| SSB index (when | 63 | 62 | . . . | 40 | 41 | . . . | 0 |
| SFN is equal to 1) | | | | | | | |
| SSB index (when | 42 | 43 | . . . | 63 | 0 | . . . | 41 |
| SFN is equal to 2) | | | | | | | |
| SSB index (when | 21 | 20 | . . . | 0 | 63 | . . . | 22 |
| SFN is equal to 3) | | | | | | | |

Calculation Process 2

The base station changes the relation between the SSB transmission positions and the SSB indexes based on the periodically changed signal (information) such as the SFN and half frame bit included in the PBCH to be indicated to the terminal and a PCID of the base station.

The terminal assumes that the relation between the SSB transmission positions and the SSB indexes is changed based on the periodically changed signal such as the SFN and half frame bit included in the PBCH indicated by the base station and the broadcast information such as the PCID.

As will be described in relation to the following calculation examples, by changing the relation information taking the PCID into account, the combination of interference beams between cells is temporally changed, so that the interference between the cells is randomized.

### Calculation Example 2-1

The base station shifts the SSB indexes with respect to the SSB transmission positions by a predetermined fixed amount based on the periodically changed signal (information) such as the SFN and half frame bit included in the PBCH to be indicated to the terminal and the PCID of the base station.

The terminal specifies (determines) the relation between the SSB transmission positions and the SSB indexes by shifting the SSB indexes from the SSB transmission positions by a fixed amount based on the periodically changed signal such as the SFN and half frame bit included in the PBCH indicated by the base station and the broadcast information such as the PCID.

For example, the SSB indexes are calculated using following Expression 3.

[3]

SSB_index=(SSBₚₒₛ−K_{PCID}*N*(SFN*2+Half_frame_bit))mod L (Expression 3)

Here, SSBₚₒₛ is the SSB transmission position. L is the maximum number of SSB indexes to be transmitted. N is a fixed shift amount. K_{PCID} is a fixed factor based on the PCID. Note that N may be a different value among a plurality of different Ls or a plurality of different SCSs.

While fixed shift amount N in calculation example 1-1 is changed depending on the PCID in the above descriptions, M described in calculation example 1-2 may be changed depending on the PCID. M changed depending on the PCID makes it possible to realize randomization of inter-cell interference while obtaining the benefits of calculation example 1-1 or calculation example 1-2.

Exemplary Relation 2-1

The SSB indexes for the SSB transmission positions based on calculation example 2-1 are described below. Table 6 shows an exemplary relation between the SSB transmission positions and the SSB indexes in a case where L=64, N=11, the periodicity of SS burst set is 10 ms (one radio frame), and half frame bit=0. In addition, Table 6 shows an exemplary relation between the SSB transmission positions and the SSB indexes in a case where K_{PCID}=1 (if PCID mod 2==0) and K_{PCID}=2 (if PCID mod 2==1) are used depending on the PCID. In calculation example 2-1, the relation between the SSB transmission positions and the SSB indexes can be changed for each PCID.

TABLE 6
Relation between SSB transmission position
and SSB index in Calculation example 2-1

| | SSB Transmission | | | | | | | | | |
|---|---|---|---|---|---|---|---|---|---|---|
| | Position | 0 | . . . | 22 | . . . | 24 | . . . | 44 | . . . | 63 |
| if PCID | SSB index (when | 0 | . . . | 22 | . . . | 24 | . . . | 44 | . . . | 63 |
| mod | SFN is equal to 0) | | | | | | | | | |
| 2 == 0 | SSB index (when | 42 | . . . | 0 | . . . | 2 | . . . | 22 | . . . | 41 |
| | SFN is equal to 1) | | | | | | | | | |
| | SSB index (when | 20 | . . . | 41 | . . . | 43 | . . . | 0 | . . . | 19 |
| | SFN is equal to 2) | | | | | | | | | |
| if PCID | SSB index (when | 0 | . . . | 22 | . . . | 24 | . . . | 44 | . . . | 63 |
| mod | SFN is equal to 0) | | | | | | | | | |
| 2 == 1 | SSB index (when | 20 | . . . | 41 | . . . | 43 | . . . | 0 | . . . | 19 |
| | SFN is equal to 1) | | | | | | | | | |
| | SSB index (when | 40 | . . . | 62 | . . . | 0 | . . . | 20 | . . . | 39 |
| | SFN is equal to 2) | | | | | | | | | |

### Calculation Example 2-2

The base station switches the changing method for changing the SSB indexes with respect to the SSB transmission positions (the method for changing the relation between the SSB transmission positions and the SSB indexes) based on the periodically changed signal (information) such as the SFN and half frame bit to be included in the PBCH to be indicated to the terminal and the PCID of the base station.

The terminal changes the changing method for changing the relation between the SSB transmission positions and the SSB indexes based on the periodically changed signal such as the SFN and half frame bit included in the PBCH indicated by the base station and the broadcast information such as the PCID.

By changing the changing method according to the PCID as described above, it is possible to achieve randomization of inter-cell interferences while achieving the benefits of calculation examples 1-1 to 1-5.

Exemplary Relation 2-2

Table 7 shows an example of switching the changing method according to the PCID. In the example of Table 7, calculation example 1-2 is applied in the case of “PCID mod 2==0,” and calculation example 1-3 is applied in the case of “PCID mod 2=1.”

TABLE 7
Relation between SSB transmission position
and SSB index in Calculation example 2-2

| | SSB Transmission Position | 0 | . . . | 22 | . . . | 44 | . . | 63 |
|---|---|---|---|---|---|---|---|---|
| if PCID | SSB index (when | 0 | . . . | 22 | . . . | 44 | . . . | 63 |
| mod | SFN is equal to 0) | | | | | | | |
| 2 == 0 | SSB index (when | 42 | . . . | 0 | . . . | 22 | . . . | 41 |
| | SFN is equal to 1) | | | | | | | |
| | SSB index (when | 20 | . . . | 41 | . . . | 0 | . . . | 19 |
| | SFN is equal to 2) | | | | | | | |
| if PCID | SSB index (when | 0 | . . . | 22 | . . . | 44 | . . . | 63 |
| mod | SEN is equal to 0) | | | | | | | |
| 2 == 1 | SSB index (when | 63 | . . . | 41 | . . . | 19 | . . . | 0 |
| | SFN is equal to 1) | | | | | | | |
| | SSB index (when | 0 | . . . | 22 | . . . | 44 | . . . | 63 |
| | SFN is equal to 2) | | | | | | | |

As described above, the base station determines the correspondence relation between the SSB transmission positions and the SSB indexes based on the broadcast signal to be transmitted. The base station changes, between the first SS burst set and the second SS burst set of the broadcast signal, the correspondence relation. The terminal determines the correspondence relation between the SSB transmission positions and the SSB indexes based on the received broadcast signal. The terminal changes, between the first SS burst set and the second SS burst set of the broadcast signal, the correspondence relation.

As described above, the base station and the terminal change the correspondence relation between the SSB transmission positions and the SSB indexes based on the broadcast signal. Therefore, the correspondence relation between the SSB transmission positions and the SSB indexes is the same between the base station and the terminal. Further, for example, even when the LBT failure occurs in the first SS burst set and the second SS burst set, the base station and the terminal change the correspondence relation between the SSB transmission positions and the SSB indexes between the first SS burst set and the second SS burst set, and thus can receive the SSB indexes different between the first SS burst set and the second SS burst set. Thus, the terminal can receive all the SSB indexes even when the LBT failure occurs.

### Embodiment 2

In Embodiment 2, the base station and the terminal calculate the relation between the SSB transmission positions and the SSB indexes based on a signal periodically transmitted by the base station and signaling information of SIB1 to which the relation information on the relation between the SSB transmission positions and the SSB indexes is added.

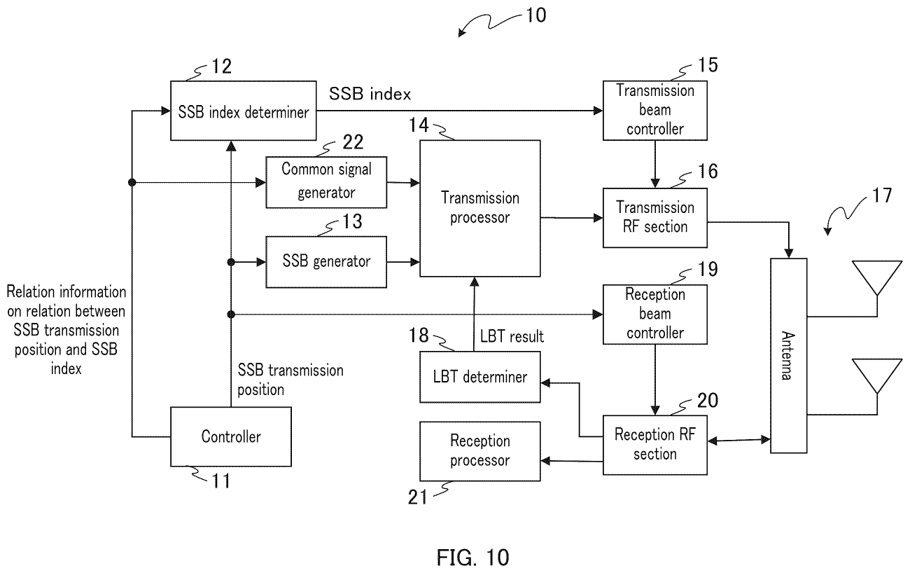

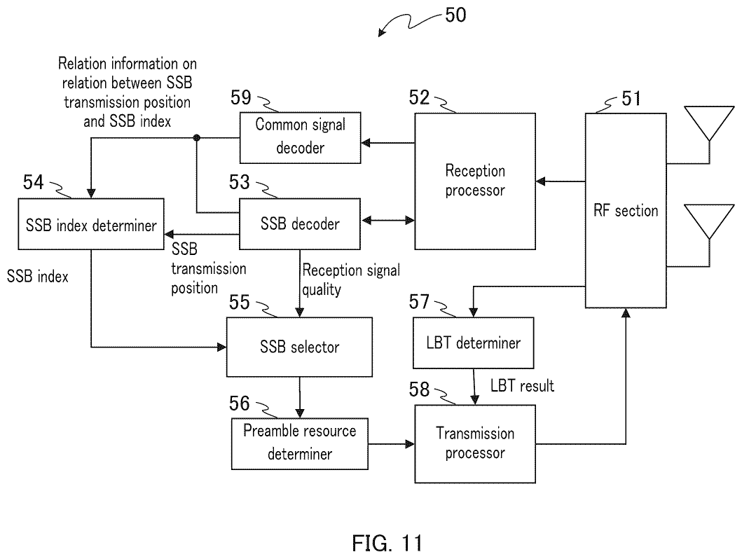

FIG. 10 is a block diagram illustrating a configuration example of base station 10 according to Embodiment 2. In FIG. 10, the same components as those in FIG. 6 are denoted by the same reference numerals.

Controller 11 outputs the relation information on the relation between the SSB transmission positions and the SSB indexes to SSB index determiner 12 and common signal generator 22. In addition, controller 11 changes the relation information on the relation between the SSB transmission positions and the SSB indexes in accordance with the control of a higher network. When the relation between the SSB transmission positions and the SSB indexes is changed, update information is outputted to common signal generator 22. The other operations are the same as those of Embodiment 1.

Common signal generator 22 generates a data signal for broadcasting SIB1 for initial connection and a control signal for indicating assigned resources for the data signal, and outputs the data signal and the control signal to transmission processor 14. The signaling information included in SIB1 includes the relation information on the relation between the SSB transmission positions and the SSB indexes inputted by controller 11. When the relation information on the relation between the SSB transmission positions and the SSB indexes is changed, the change is indicated by means of SIB1 from the base station to the terminal.

In FIG. 10, the SSB transmission positions are input to reception beam controller 19 as in FIG. 6, and ROs are associated with the SSB transmission positions. However, the SSB indexes may be inputted to reception beam controller 19 and the ROs may be associated with the SSB indexes as in FIG. 7.

FIG. 11 is a block diagram illustrating a configuration example of terminal 50 according to Embodiment 2. In FIG. 11, the same components as those in FIG. 8 are denoted by the same reference numerals.

Reception processor 52 identifies the resources for the SSBs and provides an output to SSB decoder 53 as in FIG. 8. Then, reception processor 52 obtains the SSB transmission positions from SSB decoder 53. Reception processor 52 specifies the assigned resources for the control signal of the common signal from the SSB transmission positions. Reception processor 52 obtains a data sequence of the common signal and outputs the data sequence to common signal decoder 59.

Common signal decoder 59 decodes the control signal indicating the assigned resources for the data signal for initial connection, and decodes SIB1 from the data signal. The relation information on the relation between the SSB transmission positions and the SSB indexes is obtained from the signaling information included in SIB1, and is outputted to SSB index determiner 54.

SSB index determiner 54 determines the SSB indexes from the SSB transmission positions based on the relation information on the relation between the SSB transmission positions and the SSB indexes inputted by SSB decoder 53 and common signal decoder 59, and outputs the SSB indexes to the SSB selector.

<Initial Connection Operation of Base Station and Terminal Performed when SSB Transmission Position and SSB Index are Different from Each Other>

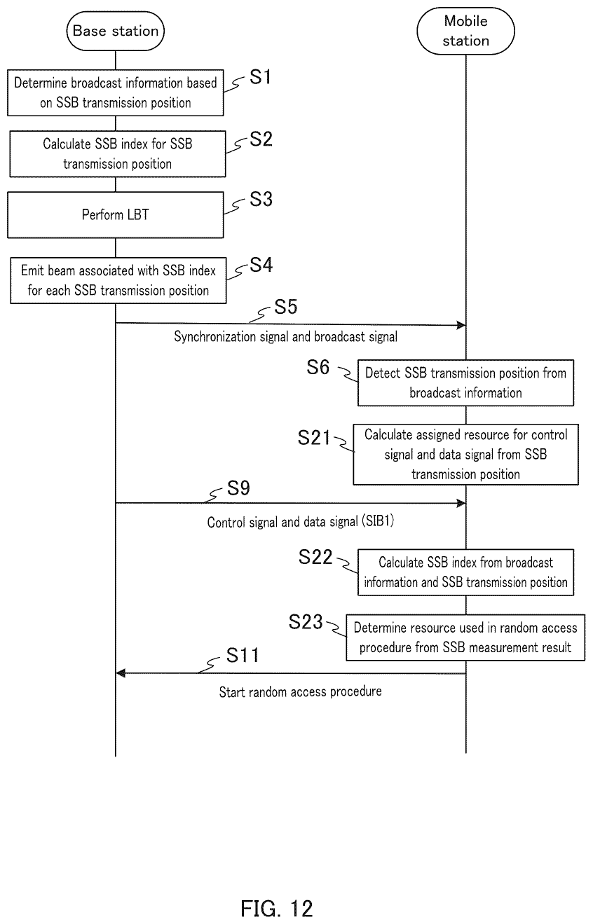

FIG. 12 is a diagram illustrating an exemplary operation of from cell search to a random access procedure performed between the base station and the terminal according to Embodiment 2. In FIG. 12, the same processes as in FIG. 9 are denoted by the same reference numerals. Hereinafter, process portions different between FIG. 12 and FIG. 9 will be described.

In the operation of FIG. 12, after detecting the SSB transmission positions in S6, the terminal calculates the assigned resources for the control signal and the data signal from the SSB transmission positions (S21). The terminal receives the control signal and the data signal (SIB1) from the base station with reference to the assigned resources calculated in S21 (S9). SIB1 includes information for changing the relation between the SSB transmission positions and the SSB indexes (for example, information for changing the shift amount).

The terminal calculates the SSB indexes based on the broadcast information, the SSB transmission positions detected in S6, and the information included in SIB1 (S22). The terminal determines, from an SSB measurement result (the SSB transmission positions or SSB indexes), resources (e.g., ROs) to be used in the random access procedure (S23).

The process of FIG. 12 differs from the process of FIG. 8 in that the terminal cannot calculate the SSB indexes until SIB1 is decoded. Therefore, the terminal calculates the assigned resources for the common signal for SIB1 from the SSB transmission positions (S21).

At the time of the random access procedure, the terminal specifies both the SSB transmission positions and SSB indexes. Thus, for the base station and the terminal, the ROs may be associated with either the SSB transmission positions or the SSB indexes. Further, the base station may switch association of the ROs with either the SSB transmission positions or the SSB indexes, and indicate the association to the terminal by SIB1.

<Operation of Calculating SSB Index from SSB Transmission Position>>

Next, the process of calculating the SSB indexes from the SSB transmission positions performed by the SSB index determiners of the base station and the terminal will be described. In the following description, the operation at the terminal side will be described. The base station performs calculation in the same operation as that of the terminal.

Details of calculation process 3 will be described below. The calculation expression used in the calculation process may be system common information specified in the specifications or signaling information given by the base station.

### Calculation Process 3

The base station changes the relation between the SSB transmission positions and the SSB indexes based on the periodically changed signal (information) such as the SFN and half frame bit included in the PBCH to be indicated to the terminal and the signaling information given to SIB1.

The terminal calculates the SSB indexes from the SSB transmission positions based on the periodically changed signal such as the SFN and half frame bit included in the PBCH indicated by the base station and the signaling information indicated by the base station using SIB1.

Since the relation between the SSB transmission positions and the SSB indexes can be changed by the SIB1 signaling information from the base station, the base station can perform adaptive control, for example, by switching the changing method according to the interference state of the cell of the base station.

### Calculation Example 3-1

The base station shifts the SSB indexes with respect to the SSB transmission positions by a predetermined amount based on the periodically changed signal (information) such as the SFN and half frame bit included in the PBCH to be indicated to the terminal and the signaling information of SIB1.

The terminal specifies the relation between the SSB transmission positions and the SSB indexes by shifting the SSB indexes by a predetermined amount from the SSB transmission positions based on the periodically changed signal such as the SFN and half frame bit included in the PBCH indicated by the base station and the SIB1 signaling information.

For example, the SSB indexes are calculated using following Expression 4.

[4]

SSB_index=(SSBₚₒₛ−N_{sig}*(SFN*2+Half_frame_bit))mod L (Expression 4)

Here, SSBₚₒₛ is the SSB transmission position. L is the maximum number of SSB indexes to be transmitted. N_{sig} is a shift amount for each cell indicated by SIB1. Note that N_{sig} may be a different value among a plurality of different Ls or a plurality of different SCSs.

In the above descriptions, N_{sig} used in place of fixed shift amount N in calculation example 1-1 is changed, but M_{sig} used in place of M described in calculation example 1-2 may also be changed.

By changing the shift amount based on the SIB1 signaling information, it is possible to adjust the shift amount for each cell, so as to achieve randomization of inter-cell interference that is more flexible than in calculation example 1-1, calculation example 1-2, or calculation example 2-1.

### Calculation Example 3-2

The base station switches the changing method for changing the SSB indexes with respect to the SSB transmission positions based on the SIB1 signaling information. The base station changes the SSB indexes with respect to the SSB transmission positions based on the periodically changed signal (information) such as the SFN and half frame bit included in the PBCH to be indicated to the terminal and the broadcast information such as the PCID.

The terminal changes the changing method for changing the SSB indexes with respect to the SSB transmission positions based on the SIB1 signaling information. The terminal specifies the SSB indexes from the SSB transmission positions based on the periodically changed signal such as the SFN and half frame bit included in the PBCH indicated by the base station and the broadcast information such as the PCID

Note that the changing method at this time may be any of the methods of calculation examples 1-1 to 1-5. Further, the changing method may include the PCID and may be any of the methods of calculation examples 2-5 to 2-3.

As described above, by switching the changing method based on the SIB1 signaling information, it is possible to adaptively control the randomization of the inter-cell interference while obtaining the benefits of calculation examples 1-1 to 1-5 or calculation examples 2-1 to 2-3.

### Calculation Example 3-3

Based on an on/off flag included in the SIB1 signaling information, the base station performs a control as to whether or not to adapt the change in the changing method for changing the SSB indexes with respect to the SSB transmission positions. The base station switches the changing method for changing the SSB indexes with respect to the SSB transmission positions based on the periodically changed signal (information) such as the SFN and half frame bit included in the PBCH to be indicated to the terminal and the broadcast information such as the PCID.

Based on the on/off flag included in the SIB1 signaling information, the terminal determines whether or not a change in the changing method for changing the SSB indexes with respect to the SSB transmission positions is adapted. When the change in the changing method is adapted, the terminal specifies the SSB indexes from the SSB transmission positions based on the periodically changed signal such as the SFN and half frame bit included in the PBCH indicated by the base station and the broadcast information such as the PCID.

The changing method at this time may be any of calculation examples 1-1 to 1-5 or any of calculation examples 2-1 to 2-3.

As in calculation processes 1 and 2, the changing method is changed according to the SFN and half frame bit included in the PBCH, PCID, and the like, and switching is performed according to the on/off flag in the SIB1 signaling information. Thus, the amount of information included in the SIB1 signaling information may be only 1 bit, and the amount of information to be added can be minimized.

As described above, the terminal and the base station change the shift amount for the correspondence relation between the SSB transmission positions and the SSB indexes based on the information included in SIB1. In addition, the terminal and the base station switch the changing methods for changing the correspondence relation between the SSB transmission positions and the SSB indexes based on information included in SIB1. This also allows the terminal to receive the SSB indexes even when the LBT failure occurs.

### Embodiment 3

In Embodiment 3, the base station and the terminal calculate the relation between the SSB transmission positions and the SSB indexes based on the signal transmitted aperiodically by the base station.

<SSB Measurement Operation of Base Station and Terminal Performed when SSB Transmission Position and SSB Index are Different from Each Other>

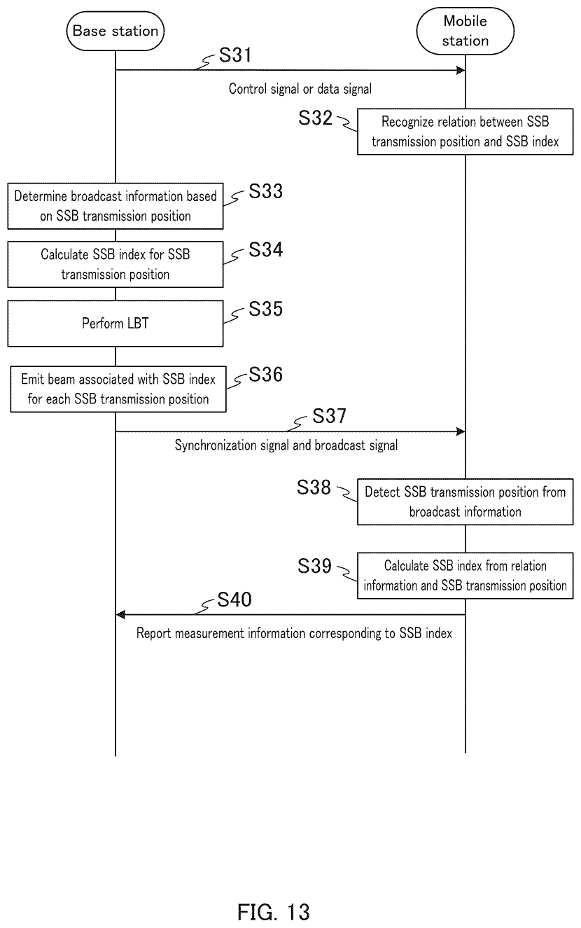

FIG. 13 illustrates an exemplary operation of from signal quality measurement and measurement information report performed using the SSB between the base station and the terminal according to Embodiment 3. The base station transmits a control signal or data signal (S31). The control signal or data signal is transmitted aperiodically (arbitrarily). The control signal may be a Physical Downlink Control CHannel (PDCCH). The data signal may be a Physical Downlink Shared CHannel (PDSCH).

The terminal recognizes (determines) the relation between the SSB transmission positions and the SSB indexes based on the control signal or the data signal received at S31 (S32).

The base station determines the broadcast information based on the SSB transmission positions (S33). The base station calculates the SSB indexes for the SSB transmission positions (S34). The base station performs the LBT (S35). If not in LBT-busy, the base station emits beams associated with the SSB indexes for the respective SSB transmission positions (S36) and transmits a synchronization signal and a broadcast signal (S37).

The terminal detects the SSB transmission positions from the broadcast information of the broadcast signal received in S37 (S38). The terminal calculates the SSB indexes with reference to the relation between the SSB transmission positions and the SSB indexes determined in S32 using the SSB transmission positions detected in S38 (S39). The terminal measures the signal qualities of beam signals for the SSB indexes calculated in S39, and transmits the measured information to the base station (S40).

In FIG. 13, the terminal cannot obtain a time frame or a resource for the initial connection from the SSBs without the relation information since the relation information on the relation between the SSB transmission positions and the SSB indexes is changed based on the signal to be transmitted aperiodically. Therefore, the base station indicates the relation information on the relation between the SSB transmission positions and the SSB indexes to the terminal in advance. That is, Embodiment 3 assumes the SSB operation in a non initial connection state.

Examples of such an SSB operation include an operation in which a channel quality measurement SSB is transmitted in a secondary cell in a resource and/or a frequency band different from those for the synchronization SSB for initial connection. Therefore, the process according to Embodiment 3 may be limited to application to the measurement SSB and not to the SSB for initial connection.

In FIG. 13, the base station and the terminal recognize the relation between the SSB transmission positions and the SSB indexes prior to transmitting the SS burst set. Thus, the base station and the terminal can calculate the SSB indexes at the time point of process $32, S34 or S39, for example.

### Calculation Process 4

The base station changes the relation between the SSB transmission positions and the SSB indexes based on the signaling information included in a data signal to be indicated to the terminal.

The terminal calculates the SSB indexes from the SSB transmission positions based on the signaling information included in the data signal indicated by the base station.

Since the relation between the SSB transmission positions and the SSB indexes can be changed according to the signaling information from the base station, the base station can perform adaptive control, such as, for example, switching the changing methods according to the interference state of the cell of the base station as in calculation process 3.

### Calculation Process 5

The base station changes the relation between the SSB transmission positions and the SSB indexes based on, for example, Downlink Control Information (DCI) included in a control signal to be indicated to the terminal.

The terminal calculates the SSB indexes from the SSB transmission positions based on the DCI included in the control signal indicated by the base station.

Since the relation between the SSB transmission positions and the SSB indexes can be changed according to the DCI from the base station, the base station can perform adaptive control, such as, for example, switching the changing method depending on the interference state of the cell of the base station as in calculation process 3. In addition, since the relation information can be changed according to the DCI, dynamic switching is possible.

As described above, the base station and the terminal determine the relation between the SSB transmission positions and the SSB indexes based on the signal aperiodically transmitted by the base station. This also allows the terminal to receive the SSB indexes even when the LBT failure occurs.

The embodiments of the present disclosure have been described.

Although the above embodiments have been described by taking an example of the application in the 52.6 GHz-71 GHz bands, the present disclosure is not limited to this, and may be used in a band lower than 52.6 GHz and a band higher than 71 GHz. The present disclosure obtains the same advantages when a large number of SSBs are to be transmitted or the number of SSBs that can be indicated and/or the transmission period of the DBTW are limited.

Although the above embodiments have been described by taking an example of application in an unlicensed band, the present disclosure is not limited to this, and may be used in a licensed band. In the case of application to the licensed band, it is possible to obtain the effect of randomization of inter-cell interference achieved by randomization of the directions of transmission beams of the base station and the effect of cost reduction of radio apparatuses which is achieved as a result of sharing the operation method between the licensed band and the unlicensed band.

The embodiments described above may be limited to cases where the total number of SSB indexes is equal to or greater than X. For example, when the number of SSB transmission positions that can be indicated is 64, X=32 may be set. That is, the embodiments may be applied in a case where the number of SSB indexes exceeds half of the number of SSB transmission positions and there are SSBs which cannot be cyclically transmitted.

The application of the above embodiments may be switched based on the capability information on the terminal. For example, when it is known that the base station is operated in an optional band based on the capability information on the terminal, the above-described embodiments may be applied.

In the specifications (for example, see NPL 3), the “SSB transmission position” in the present disclosure may be exchanged by “candidate SS/PBCH block index” or “SSB candidate position.” The “SSB index” may be replaced with “SS/PBCH block index” or “SSB candidate index.”

In the above embodiments, the relation between the SSB transmission positions and the SSB indexes is changed, but the correspondence relation between RO resource numbers and the SSB indexes may be changed similarly. With this change, it is possible to obtain effects similar to those described in the embodiments with respect to the random access. For example, as shown in Table 8, the SSB indexes corresponding to the RO resource numbers are changed depending on the SFNs. In this way, uplink interference related to random access from the terminal can be randomized.

TABLE 8
Correspondence relation between
RO resource number and SSB index

| RO resource number | 0 | 1 | 2 | . . . | 30 | 31 |
|---|---|---|---|---|---|---|
| Corresponding SSB | 0, 1 | 2, 3 | 4, 5 | . . . | 60, 61 | 62, 63 |
| index (when SFN is | | | | | | |
| equal to 0) | | | | | | |
| SSB index (when | 2, 3 | 4, 5 | 6, 7 | . . . | 62, 63 | 0, 1 |
| SFN is equal to 1) | | | | | | |
| SSB index (when | 4, 5 | 6, 7 | 8, 9 | . . . | 0, 1 | 2, 3 |
| SFN is equal to 2) | | | | | | |
| SSB index (when | 6, 7 | 8, 9 | 10, 11 | . . . | 2, 3 | 4, 5 |
| SFN is equal to 3) | | | | | | |

In the above, the terminal may be referred to as, for example, a user equipment (UE) or a mobile station. The base station may be referred to as a gNB, for example.

Further, any component termed with “processor” or with a suffix, such as “-er,” “-or,” or “-ar” in the above-described embodiments may be replaced with other terms such as “circuit (circuitry),” “device,” “unit,” or “module.”

### (Supplement)

Information indicating whether or not the terminal supports the functions, operations, or processes described in the above embodiments may be transmitted (or indicated) by the terminal to the base station, for example, as the capability information or capability parameters of the terminal.

The capability information may include an information element (IE) individually indicating whether or not the terminal supports at least one of the functions, operations, or processes described in the above-described embodiments. Alternatively, the capability information may include an information element indicating whether or not the terminal supports a combination of any two or more of the functions, operations, or processes described in the above-described embodiments.

The base station may determine (or otherwise determine or assume) the function, operation, or process supported (or unsupported) by a terminal which transmitted the capability information, for example, based on the capability information received from the terminal. The base station may perform an operation, process, or control according to a determination result based on the capability information. For example, the base station may control allocation (i.e., scheduling) of at least one of the downlink resources such as the PDCCH or PDSCH and the uplink resources such as the PUCCH or PUSCH, based on the capability information received from the terminal.

Note that not supporting, by the terminal, some of the functions, operations, or processes described in each of the above-described embodiments may be read as restrictions on some of such functions, operations, or processes in the terminal. For example, information or requests regarding such restrictions may be indicated to the base station.

The information regarding the capability or restrictions of the terminal may be defined, for example, in a standard, or may be implicitly indicated to the base station in association with information known to the base station or information transmitted to the base station.

### (Control Signal)

In the present disclosure, the downlink control signal (or downlink control information) according to one exemplary embodiment of the present disclosure may be a signal (or information) transmitted in a Physical Downlink Control Channel (PDCCH) in a physical layer, for example, or may be a signal (or information) transmitted in a Medium Access Control Control Element (MAC CE) or a Radio Resource Control (RRC) in a higher layer. Further, the signal (or information) is not limited to that notified by the downlink control signal, but may be predefined in the specifications (or standard) or may be pre-configured for the base station and the terminal.

In the present disclosure, the uplink control signal (or uplink control information) relating to the exemplary embodiment of the present disclosure may be, for example, a signal (or information) transmitted in a PUCCH of the physical layer or a signal (or information) transmitted in the MAC CE or RRC of the higher layer. In addition, the signal (or information) is not limited to a case of being indicated by the uplink control signal and may be previously specified by the specifications (or standards) or may be previously configured in a base station and a terminal. Further, the uplink control signal may be replaced with, for example, uplink control information (UCI), 1st stage sidelink control information (SCI), or 2nd stage SCI.

### (Base Station)

In one exemplary embodiment of the present disclosure, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Furthermore, in the sidelink communication, the terminal may play a role of a base station. Further, instead of the base station, a relay apparatus that relays communication between a higher node and a terminal may be used. Moreover, a road side device may be used.

### (Uplink/Downlink/Sidelink)

One exemplary embodiment of the present disclosure may be applied to, for example, any of the uplink, downlink, and sidelink. For example, one exemplary embodiment of the present disclosure may be applied to a Physical Uplink Shared Channel (PUSCH), a Physical Uplink Control Channel (PUCCH), and a Physical Random Access Channel (PRACH) in the uplink, a Physical Downlink Shared Channel (PDSCH), PDCCH or a Physical Broadcast Channel (PBCH) in the downlink, or a Physical Sidelink Shared Channel (PSSCH), a Physical Sidelink Control Channel (PSCCH), a Physical Sidelink Broadcast Channel (PSBCH) in the sidelink.

The PDCCH, the PDSCH, the PUSCH, and the PUCCH are examples of a downlink control channel, a downlink data channel, an uplink data channel, and an uplink control channel, respectively. Further, the PSCCH and the PSSCH are examples of a sidelink control channel and a sidelink data channel, respectively. Further, the PBCH and the PSBCH are examples of a broadcast channel, and the PRACH is an example of a random access channel.

### (Data Channels/Control Channels)

One exemplary embodiment of the present disclosure may be applied to, for example, any of a data channel and a control channel. For example, in one exemplary embodiment of the present disclosure, a channel in one exemplary embodiment of the present disclosure may be replaced with any of a PDSCH, a PUSCH, and a PSSCH for the data channel, or a PDCCH, a PUCCH, a PBCH, a PSCCH, and a PSBCH for the control channel.

### (Reference Signals)

In one exemplary embodiment of the present disclosure, the reference signals are, for example, signals known to both a base station and a mobile station and each reference signal may be referred to as a reference signal (RS) or sometimes a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### (Time Intervals)

In one exemplary embodiment of the present disclosure, the units of time resources are not limited to one or a combination of slots and symbols, but may be time resource units such as, for example, frames, superframes, subframes, slots, time slot subslots, minislots, or symbols, Orthogonal Frequency Division Multiplexing (OFDM) symbols, Single Carrier-Frequency Division Multiplexing (SC-FDMA) symbols, or other time resource units. The number of symbols included in one slot is not limited to any number of symbols exemplified in the embodiments described above and may be other numbers of symbols.

### (Frequency Band)

One exemplary embodiment of the present disclosure may be applied to either of a licensed band or an unlicensed band.

### (Communication)

One exemplary embodiment of the present disclosure may be applied to any of communication between a base station and a terminal (Uu link communication), communication between a terminal and a terminal (Sidelink communication), and communication of a Vehicle to Everything (V2X). In one example, a channel in one exemplary embodiment of the present disclosure may be replaced with any of a PSCCH, a PSSCH, a Physical Sidelink Feedback Channel (PSFCH), a PSBCH, a PDCCH, a PUCCH, a PDSCH, a PUSCH, and a PBCH.

Further, one exemplary embodiment of the present disclosure may be applied to either of terrestrial networks or a non-terrestrial network (NTN) such as communication using a satellite or a high-altitude pseudolite (High Altitude Pseudo Satellite (HAPS)). Further, one exemplary embodiment of the present disclosure may be applied to a terrestrial network having a large transmission delay compared to the symbol length or slot length, such as a network with a large cell size and/or an ultra-wideband transmission network.

### (Antenna Ports)

In one exemplary embodiment of the present disclosure, the antenna port refers to a logical antenna (antenna group) configured of one or more physical antennae. For example, the antenna port does not necessarily refer to one physical antenna and may refer to an array antenna or the like configured of a plurality of antennae. In one example, the number of physical antennae configuring the antenna port may not be specified, and the antenna port may be specified as the minimum unit with which a terminal station can transmit a Reference signal. Moreover, the antenna port may be specified as the minimum unit for multiplying a weight of a Precoding vector.

### <5G NR System Architecture and Protocol Stack>

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC

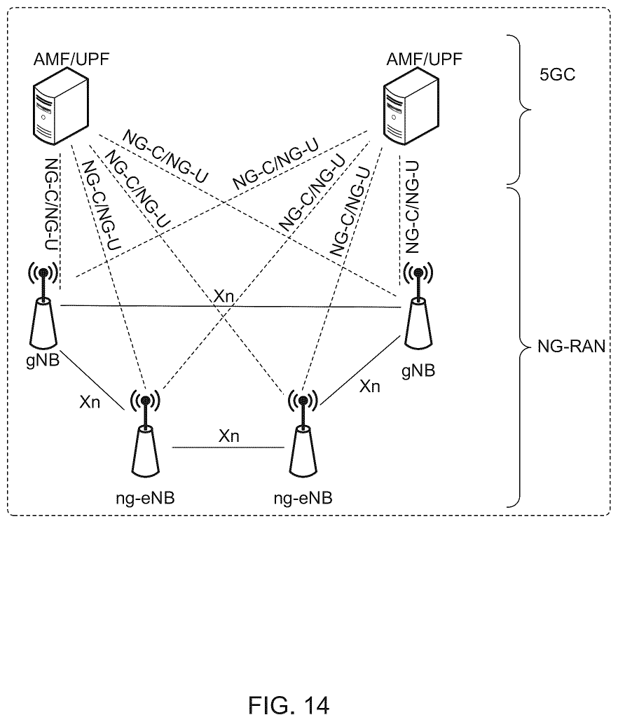

(Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 14 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side. Additionally, a new Access Stratum (AS) sublayer (SDAP. Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, 60 kHz, and so forth. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grids is called a resource element and is identified based on the frequency index in the frequency domain and the symbol position in the time domain (see 3GPP TS 38.211 v15.6.0).

### <Functional Split Between NG-RAN and 5GC in 5G NR>

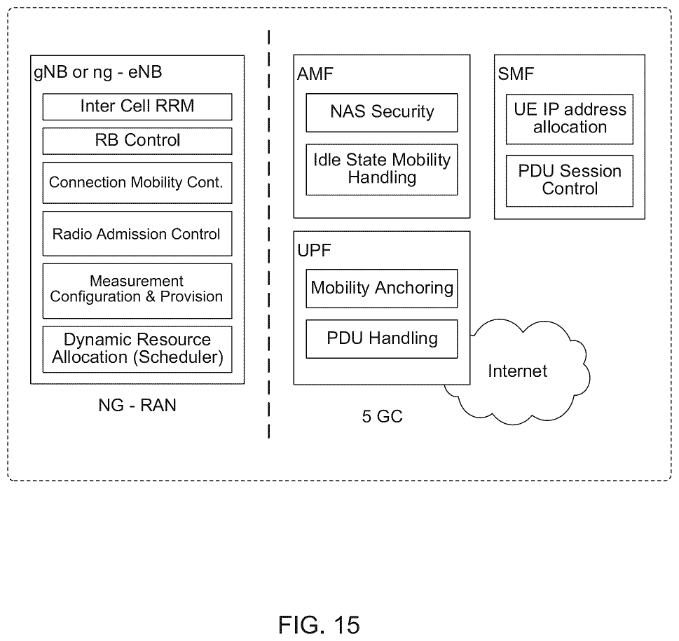

FIG. 15 illustrates the functional split between the NG-RAN and the 5GC. NG-RAN logical node is a gNB or ng-eNB. The 5GC has logical nodes AMF, UPF and SMF.

For example, gNB and ng-eNB hosts the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Function of Non-Access Stratum (NAS) signaling termination;
NAS signaling security;
Access Stratum, AS, Security control;
Inter-Core Network (CN) node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function (SMF) selection.

Furthermore, the User Plane Function, UPF, hosts the following main functions:
Anchor point for Intra-/Inter-RAT mobility (when applicable);
External Protocol Data Unit (PDU) session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Function of downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink data notification.

### <RRC Connection Setup and Reconfiguration Procedure>

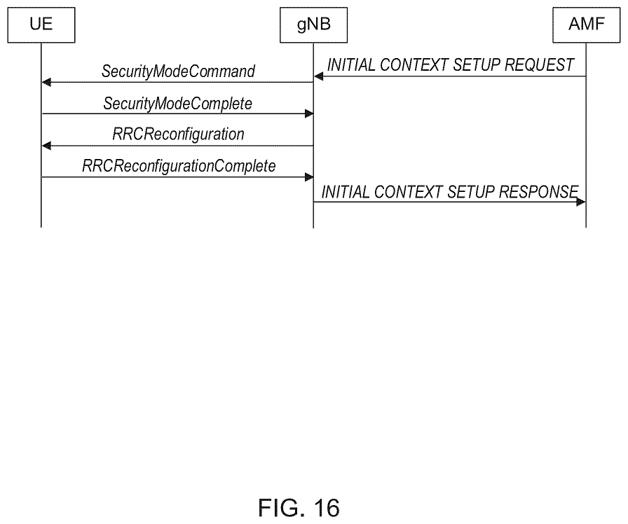

FIG. 16 illustrates some interactions between a UE, gNB, and AMF (a 5GC Entity) performed in the context of a transition of the UE from RRC_IDLE to RRC_CONNECTED for the NAS part (see TS 38 300 v15.6.0).

RRC is a higher layer signaling (protocol) used for UE and gNB configuration. With this transition, the AMF prepares UE context data (which includes, for example, a PDU session context, security key. UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB informs the AMF that the setup procedure is completed with the INITIAL CONTEXT SETUP RESPONSE.

Thus, the present disclosure provides a 5th Generation Core (5GC) entity (e.g., AMF. SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### <Usage Scenarios of IMT for 2020 and Beyond>

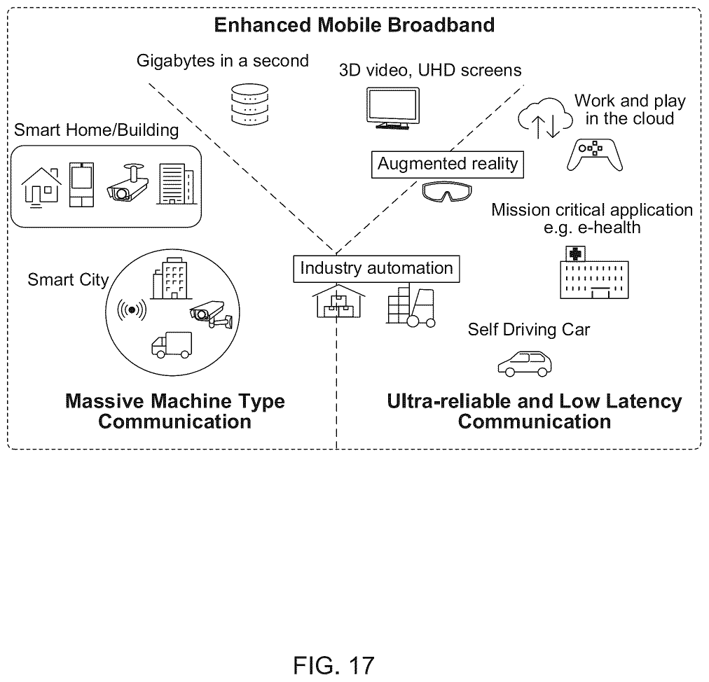

FIG. 17 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 17 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10-6 level), higher availability, packet sizes of up to 256 bytes, time synchronization up to the extent of a few μs (where the value can be one or a few us depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### <Qos Control>

The 5G QoS (Quality of Service) model is based on QoS flows and supports both Qos flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearer (DRB) together with the PDU Session, e.g., as illustrated above with reference to FIG. 16. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

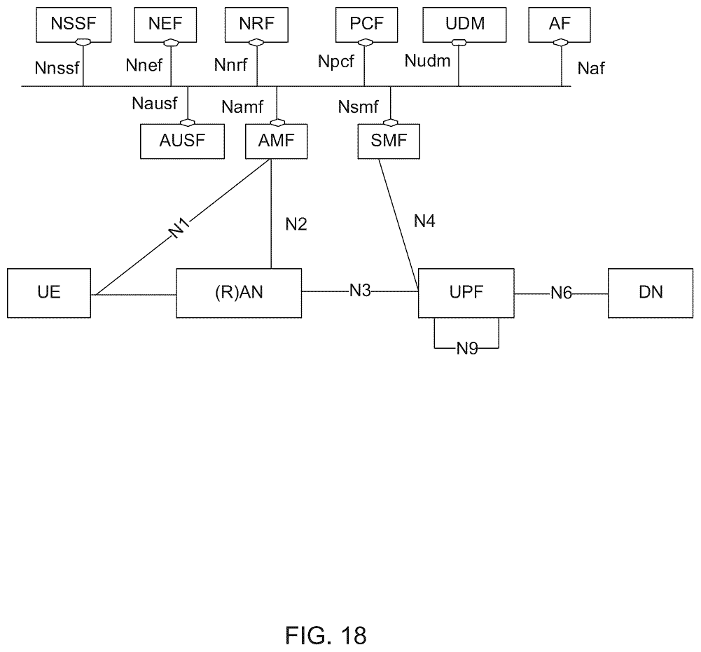

FIG. 18 illustrates a 5G NR non-roaming reference architecture (see TS 23.501 v16.1.0, section 4.23). An Application Function (AF), e.g., an external application server hosting 5G services, exemplarily described in FIG. 17, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 18 illustrates further functional units of the 5G architecture, namely Network Slice Selection Function (NSSF). Network Repository Function (NRF), Unified Data Management (UDM). Authentication Server Function (AUSF), Access and Mobility Management Function (AMF), Session Management Function (SMF), and Data Network (DN), e.g., operator services, Internet access or 3rd party services. All of or a part of the core network functions and the application services may be deployed and running on cloud computing environments.

In the present disclosure, thus, an application server (for example, AF of the 5G architecture), is provided that includes: a transmitter, which, in operation, transmits a request containing a QoS requirement for at least one of URLLC, eMMB and mMTC services to at least one of functions (for example NEF, AMF, SMF, PCF, UPF, etc.) of the 5GC to establish a PDU session including a radio bearer between a gNodeB and a UE in accordance with the QoS requirement; and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IOT).”

The communication may include exchanging data through, for example, a cellular system, a wireless LAN system, a satellite syste, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A terminal according to one exemplary embodiment of the present disclosure includes: reception circuitry, which, in operation, receives a synchronization signal; and control circuitry, which, in operation, determines a correspondence relation between a transmission position of a synchronization signal block and an index of the synchronization signal block, in which the control circuitry changes the correspondence relation between a first reception timing and a second reception timing of the synchronization signal block.

In one exemplary embodiment of the present disclosure, the control circuitry changes the correspondence relation by shifting the index of the synchronization signal block with respect to the transmission position of the synchronization signal block by a fixed amount.

In one exemplary embodiment of the present disclosure, the control circuitry changes the correspondence relation by shifting the index of the synchronization signal block with respect to the transmission position of the synchronization signal block depending on a system frame number.

In one exemplary embodiment of the present disclosure, the control circuitry reverses the correspondence relation of the index of the synchronization signal block with respect to the transmission position of the synchronization signal block between the first reception timing and the second reception timing.

In one exemplary embodiment of the present disclosure, the control circuitry changes the correspondence relation by inputting a system frame number into a pseudo-random number expression.

In one exemplary embodiment of the present disclosure, the control circuitry changes the correspondence relation using a system frame number with reference to a table indicating the correspondence relation for each system frame number.

In one exemplary embodiment of the present disclosure, the control circuitry changes the correspondence relation using a cell identifier.

In one exemplary embodiment of the present disclosure, using a cell identifier or information included in a System Information Block (SIB), the control circuitry switches a changing method for changing the correspondence relation.

In one exemplary embodiment of the present disclosure, based on information included in a System Information Block (SIB), the control circuitry changes the fixed amount of the shifting.

In one exemplary embodiment of the present disclosure, based on information included in a System Information Block (SIB), the control circuitry changes a shift amount of the shifting.

In one exemplary embodiment of the present disclosure, the control circuitry changes the correspondence relation further based on a physical downlink control channel (PDCCH) or a physical downlink shared channel (PDSCH).

A base station according to one exemplary embodiment of the present disclosure includes: transmission circuitry, which, in operation, transmits a synchronization signal; and control circuitry, which, in operation, determines a correspondence relation between a transmission position of a synchronization signal block and an index of the synchronization signal block, in which the control circuitry changes the correspondence relation between a first transmission timing and a second transmission timing of the synchronization signal block.

A communication method according to one exemplary embodiment of the present disclosure includes steps performed by a terminal of: receiving a synchronization signal; determining a correspondence relation between a transmission position of a synchronization signal block and an index of the synchronization signal block; and changing the correspondence relation between a first reception timing and a second reception timing of the synchronization signal block.

A communication method according to one exemplary embodiment of the present disclosure includes steps performed by a base station of: transmitting a synchronization signal; determining a correspondence relation between a transmission position of a synchronization signal block and an index of the synchronization signal block; and changing the correspondence relation between a first transmission timing and a second transmission timing of the synchronization signal block.

The disclosure of Japanese Patent Application No. 2021-056210, filed on Mar. 29, 2021, including the specification, drawings and abstract, is incorporated herein by reference in its entirety.

### INDUSTRIAL APPLICABILITY

One aspect of the present disclosure is useful in radio communication systems.

### REFERENCE SIGNS LIST

10 Base station
11 Controller
12 SSB index determiner
13 SSB generator
14 Transmission processor
15 Transmission beam controller
16 Transmission RF section
17 Antenna
18 LBT Determiner
19 Reception beam controller
20 Reception RF section
21 Reception processor
22 Common signal generator
50 Terminal
51 RF section
52 Reception processor
53 SSB decoder
54 SSB index determiner
55 SSB selector
56 Preamble resource determiner
57 LBT determiner
58 Transmission processor
59 Common signal decoder

1. A terminal, comprising:
reception circuitry, which, in operation, receives a synchronization signal; and
control circuitry, which, in operation, determines a correspondence relation between a transmission position of a synchronization signal block and an index of the synchronization signal block, wherein
the control circuitry changes the correspondence relation between a first reception timing and a second reception timing of the synchronization signal block.

2. The terminal according to claim 1, wherein
the control circuitry changes the correspondence relation by shifting the index of the synchronization signal block with respect to the transmission position of the synchronization signal block by a fixed amount.

3. The terminal according to claim 1, wherein
the control circuitry changes the correspondence relation by shifting the index of the synchronization signal block with respect to the transmission position of the synchronization signal block depending on a system frame number.

4. The terminal according to claim 1, wherein
the control circuitry reverses the correspondence relation of the index of the synchronization signal block with respect to the transmission position of the synchronization signal block between the first reception timing and the second reception timing.

5. The terminal according to claim 1, wherein
the control circuitry changes the correspondence relation by inputting a system frame number into a pseudo-random number expression.

6. The terminal according to claim 1, wherein
the control circuitry changes the correspondence relation using a system frame number with reference to a table indicating the correspondence relation for each system frame number.

7. The terminal according to claim 1, wherein
the control circuitry changes the correspondence relation using a cell identifier.

8. The terminal according to claim 1, wherein
using a cell identifier or information included in a System Information Block (SIB), the control circuitry switches a changing method for changing the correspondence relation.

9. The terminal according to claim 2, wherein
based on information included in a System Information Block (SIB), the control circuitry changes the fixed amount of the shifting.

10. The terminal according to claim 3, wherein
based on information included in a System Information Block (SIB), the control circuitry changes a shift amount of the shifting.

11. The terminal according to claim 1, wherein
the control circuitry changes the correspondence relation further based on a physical downlink control channel (PDCCH) or a physical downlink shared channel (PDSCH).

12. A base station, comprising:
transmission circuitry, which, in operation, transmits a synchronization signal; and
control circuitry, which, in operation, determines a correspondence relation between a transmission position of a synchronization signal block and an index of the synchronization signal block, wherein
the control circuitry changes the correspondence relation between a first transmission timing and a second transmission timing of the synchronization signal block.

13. A communication method, comprising steps performed by a terminal of:
receiving a synchronization signal;
determining a correspondence relation between a transmission position of a synchronization signal block and an index of the synchronization signal block; and
changing the correspondence relation between a first reception timing and a second reception timing of the synchronization signal block.

14. A communication method, comprising steps performed by a base station of:
transmitting a synchronization signal;
determining a correspondence relation between a transmission position of a synchronization signal block and an index of the synchronization signal block; and
changing the correspondence relation between a first transmission timing and a second transmission timing of the synchronization signal block.
